(19) United States
(12) Patent Application Publication
(10) Pub. No.: US 2025/0141833 A1
(43) Pub. Date: May 1, 2025

(54) METHOD FOR SEAMLESSLY CHANGING A VALUE OF AN EXTENDED UNIQUE IDENTIFIER OF A NON-AP STATION ASSOCIATED WITH AN AP STATION

(71) Applicant: CANON KABUSHIKI KAISHA, Tokyo (JP)

(72) Inventors: Stéphane BARON, LE RHEU (FR); Julien SEVIN, SAINT AUBIN DU CORMIER (FR); Patrice NEZOU, LIFFRE (FR)

(21) Appl. No.: 18/836,706

(22) PCT Filed: Jan. 27, 2023
(86) PCT No.: PCT/EP2023/052013

§ 371 Date: Aug. 7, 2024

(30) Foreign Application Priority Data
Feb. 11, 2022 (GB) 2201842.8

(51) Int. Cl. H04L 61/2596; H04L 101/622; H04W 8/26

(52) U.S. Cl. CPC H04L 61/2596; H04W 8/26; H04L 2101/622

(57) ABSTRACT

According to some embodiments of the disclosure, it is provided a method for changing a value of an Extended Unique Identifier, EUI, of a non-access point, non-AP, station associated with an access point, AP, station, the non-AP station and the AP station both using a same mechanism for determining a new value of the EUI. After obtaining an EUI change start time and a transition period duration and after determining the new value of the EUI, data are transmitted to or received from the non-AP station or the AP station, using the EUI value to be changed and the new EUI value, from the obtained EUI change start time and for at most the obtained transition period duration. An item of information for obtaining the EUI change start time is received from or is transmitted to the non-AP station or the AP station.

### FIELD OF THE INVENTION

The present invention relates to wireless communications and more specifically to user privacy during wireless communications.

### BACKGROUND OF THE INVENTION

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section. Furthermore, all embodiments are not necessarily intended to solve all or even any of the problems brought forward in this section.

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks. The 802.11 family of standards adopted by the Institute of Electrical and Electronics Engineers (IEEE) provides a great number of mechanisms for wireless communications between stations.

Today, the evolution of wireless systems has brought privacy concerns at the forefront, driven by user demand and requirements of the General Data Protection Regulation (GDPR). The global wireless industry is faced with the growing need to protect users' personally identifiable information from increasingly sophisticated user tracking and user profiling activities, while continuing to improve wireless services and the user experience.

In particular, the Media Access Control (MAC) address of a user device constitutes a piece of data that can be used to track this user. Indeed, the access points (APs) of wireless networks can monitor the locations of mobile devices (tablets, laptops, mobile phones, etc.) of a user without his/her consent, by means of their MAC addresses. This is because mobile phones are configured to discover surrounding access points to wireless networks. As a user moves, his/her mobile phone sends requests to determine if there are any access points nearby, these requests identifying the mobile phone which sends these requests and including in particular the MAC address of the mobile phone. Access points that hear these requests can respond. In the context of Wi-Fi networks as defined by IEEE 802.11 standards (Wi-Fi is a trademark), this procedure is called Probe Request/Response exchange.

So even when a mobile phone is not connected to a Wi-Fi network, surrounding access points may receive its MAC address. It is then possible to track a user by reconstructing his/her trajectory from access points to which his/her mobile phone has sent its MAC address. In addition, if the mobile phone has been associated with one of the access points (i.e. the user has connected to an associated Wi-Fi network through that access point) and the user has provided personal identification information (name, place of residence, etc.) in the past, the access point may have recorded in a database the MAC address of the phone in association with the identification information. Therefore, even if the user is not connected to the Wi-Fi network, this identity information could be recovered by comparing the MAC address contained in a Probe Request to the MAC address used for the past association.

In the context of Wi-Fi networks, a solution has been proposed by the IEEE 802.11 working group to limit the risk of a user being traced, and consists in dynamically modifying the MAC address of the user device. This mechanism is called Randomized and Changing MAC (RCM) procedure. It has been originally introduced as a privacy enhancing feature in the 802.11aq Pre-Association Service Discovery Task Group and finally included in the standard IEEE Std 802.11-2020. It comprises periodical change of the MAC address of a non-AP station (i.e. a station which is not an access point) to a random value, while the non-AP station is not associated with a network (or, equivalently, with an access point). The non-AP station may construct the randomized MAC address from the locally administered address space as defined in IEEE Std 802®-2014 and IEEE Std 802c™-2017.

More specifically, a new Management Information Base (MIB) variable controllable by an external management entity has been specified. This variable is called ‘dot11MACPrivacyActivated’. When dot11MACPrivacyActivated is set to “true”, the non-AP station can apply specific mechanisms for enhancing the privacy at MAC level, including RCM.

The MAC address, or EUI-48 address, of a device is an Extended Unique Identifier (EUI) composed of 48 bits. It can be administered universally or locally. A universally administered address is uniquely assigned to the device by the manufacturer. On the contrary, a locally administered address is assigned to the device by a software or a network administrator, and replaces the physical burned-in address. The second-least-significant bit of the first octet of the MAC address, i.e. the seventh bit of the first octet of the address, also referred to as “U/L bit” (for “Universal/Local bit”), indicates whether it is universally (when set to 0) or locally (when set to 1) administered. The least-significant bit of the first octet of the MAC address, i.e. the eighth bit of the first octet of the address, also referred to as “I/G bit” (for “Individual/Group bit”), indicates whether the frame is sent to only one receiving device (when set to 0, indicating unicast transmission) or to a plurality of devices (when set to 1, indicating multicast transmission). When RCM mechanism is operated in the non-AP station, the MAC address of the non-AP station is randomly changed (for instance periodically). More specifically, the U/L bit is set to 1, the I/G bit is set to 0, and the remaining 46 bits are randomly generated by using a pseudorandom function (PRF). When the RCM is operated, counters in all sequence number spaces used to identify data frames (MAC service data units, MSDUs, packets or Management MAC Protocol Data Units, MMPDUs, frames) have to be reset and the non-AP station also resets seeds used within the PHY DATA scrambler on the next physical layer protocol data unit, PPDU, to be transmitted.

Recent solutions have been proposed to solve the issue, but all suffer from a lack of flexibility regarding the application of a new MAC address. In particular, the change of a MAC address of a non-AP station that is already registered to an AP station needs to terminate ongoing communications prior to the UID change. The same issue occurs when an AP station decides, for instance, to change critical elements of its managed network (like the frequency band). The consequence is that such needs to be carefully anticipated by all the stations in the network by stopping ongoing communication prior to the change.

Due to the fact that the user privacy mainly depends on the frequency of MAC address changes, existing mechanisms are not well adapted and drive non-AP station within the Basic Service Set (BSS) of an AP station to remain trackable.

There is thus a need for a method for enabling a non-AP station to seamlessly apply a Randomized and Changing MAC procedure without stopping existing communications established with an access point or with another non-AP station of the BSS. Such a method may be referred to as “Enhanced RCM” (ERCM) or

“Seamless Enhanced RCM” (SERCM) in the following.

### SUMMARY OF THE INVENTION

The present invention has been devised to address one or more of the foregoing concerns.

In this context, there is provided a solution for improving change of an Extended Unique Identifier such as a MAC address in a non-AP station associated with an AP station or with another non-AP station.

According to a first aspect of the invention there is provided a method for changing a value of an Extended Unique Identifier, EUI, of a non-access point, non-AP, station associated with an access point, AP, station, the non-AP station and the AP station both using a same mechanism for determining a new value of the EUI, the method comprising at one of the non-AP station and the AP station:
obtaining an EUI change start time and a transition period duration;
determining the new value of the EUI; and
from the obtained EUI change start time and for at most the obtained transition period duration, using the EUI value to be changed and the new EUI value for transmitting data to or receiving data from the other of the non-AP station and the AP station.

Accordingly, the method of the invention makes it possible to change the value of an extended unique identifier of a non-AP station associated with an AP station, without stopping existing communications established with the AP station or with another non-AP station of the BSS.

As known by the person skilled in the art, a EUI is a unique identifier assigned to the network interface controller of a device for use as a network address during wireless communications, for instance according to IEEE 802 networking technologies. Typically, a EUI may comprise 48 bits (EUI-48, also called MAC address) or 64 bits (EUI-64).

This EUI can also be a local unique identifier with a reduced number of bits typically 12 (EUI-12 also called Station AID, that stand for Association Identifier), such identifier being unique in the context of a BSS.

According to some embodiments, at least an item of information for obtaining the EUI change start time is received from or is transmitted to the other of the non-AP station and the AP station. According to other embodiments, the EUI change start time is obtained based on a common event received or detected by both the non-AP station and the AP station. According to further other embodiments, the EUI change start time is obtained from predetermined time instants known at both the non-AP station and the AP station.

Still according to some embodiments, the method further comprises, if it is determined that, before the obtained transition period duration elapsed, none of the non-AP station and the AP station needs to use the EUI value to be changed, shortening the obtained transition period duration. This makes it possible to shorten the period duration for changing the value of the EUI.

Still according to some embodiments, the method further comprises determining whether a transmission buffer of the non-AP station and/or a transmission buffer of the AP station contain data to be transmitted using the EUI value to be changed.

Still according to some embodiments, determining whether a transmission buffer of the other of the non-AP station and the AP station contains data to be transmitted using the EUI value to be changed comprises determining whether a EUI value used to transmit a frame from the other of the non-AP station and the AP station to the one of the non-AP station and the AP station is the new value of the EUI.

Still according to some embodiments, determining whether a transmission buffer of the other of the non-AP station and the AP station contains data to be transmitted using the EUI value to be changed comprises (i) transmitting a frame from the one of the non-AP station and the AP station to the other of the non-AP station and the AP station and (ii) determining whether a EUI value used to receive an acknowledgment of reception of the transmitted frame is the EUI value to be changed.

Still according to some embodiments, at least an item of information for obtaining the transition period duration is received from or is transmitted to the other of the non-AP station and the AP station.

The transition period duration may be determined as a function of an amount of data to be transmitted using the EUI value to be changed or may be predetermined. The obtained transition period duration may be transmitted to the other of the non-AP station and the AP station.

Still according to some embodiments, the method further comprises determining that a value of the EUI is to be changed.

Still according to some embodiments, the EUI of the non-AP station is a MAC address of the non-AP station, i.e. a EUI-48.

Still according to some embodiments, a request for changing the value of the EUI is sent by the AP station and received by the non-AP station. The request may be specific to one non-AP station (in this case, only the EUI of the concerned non-AP station is changed), or it may be sent to all the non-AP stations associated with the AP and supporting a EUI-changing procedure (in this case, all the EUIs of the non-AP stations are changed at the same time). For example, the request for changing the value of the EUI may be a beacon frame.

Still according to some embodiments, the item of information for obtaining the EUI change start time is a counter included in the beacon frame, the counter indicating a number of Target Beacon Transmission Times, TBTTs. For example, after sending the request for changing the value of the EUI, a plurality of subsequent beacon frames may be sent by the AP station and received by the non-AP station, each subsequent beacon frame including a respective value of the counter, the value of the counter being decremented by one unit for each subsequent beacon frame, the EUI change start time being a time at which the beacon frame with a value of the counter equal to zero is sent from the AP station and received by the non-AP station.

Still according to some embodiments, a request for changing the value of the EUI is sent by the non-AP station and received by the AP station.

Still according to some embodiments, the item of information for obtaining the EUI change start time is included in the request for changing the value of the EUI.

Still according to some embodiments, the item of information for obtaining the EUI change start time is a number k of Target Beacon Transmission Times, TBTTs, the EUI change start time being a time at which a k-th beacon frame since the communicating of the request is sent from the AP station or received by the non-AP station.

Still according to some embodiments, the item of information for obtaining the EUI change start time is a time value, the EUI change start time being a time at which a beacon frame is sent from the AP station or received by the non-AP station, the beacon frame being sent or received corresponding to a first beacon frame after the time value is reached.

Still according to some embodiments, a physical layer of the non-AP station is configured to manage at least two different values of the EUI and wherein the AP station is configured to manage a list of at least two different values of the EUI, from the obtained EUI change start time and for at most the obtained transition period duration.

According to another aspect of the disclosure there is provided a device comprising a processing unit configured for carrying out each of the steps of the method described above.

This aspect of the disclosure has advantages similar to those mentioned above.

According to some embodiments, there is provided a station identified by an Extended Unique Identifier, EUI, value, the station comprising: a memory; and a processing circuitry coupled to the memory, the processing circuitry configured to:
obtain an EUI change start time and a transition period duration;
determine a new value of the EUI; and
from the obtained EUI change start time and for at most the obtained transition period duration, use the EUI value to be changed and the new EUI value for transmitting data to or receiving data from another station.

At least parts of the methods according to the disclosure may be computer implemented. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present disclosure may take the form of a computer program product embodied in any tangible medium of expression having computer usable program code embodied in the medium.

Since the solution of the present disclosure can be implemented in software, the solution of the present disclosure can be embodied as computer readable code for provision to a programmable apparatus on any suitable carrier medium. A tangible carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Some embodiments of the present invention are illustrated by way of example, and not by way of limitation, in the figures of the accompanying drawings, in which like reference numerals refer to similar elements and in which:

FIG. 1 illustrates an example of a network system in which some embodiments of the invention may be implemented;

FIG. 2a illustrates an example of steps performed at a non-AP station for changing its MAC address, according to some embodiments of the invention;

FIG. 2b illustrates an example of steps carried out by an AP station for changing the MAC address of one of its associated non-AP stations, according to some embodiments of the invention;

FIG. 3 illustrates an example of steps performed at a non-AP station or at an AP station upon reception of a frame or when a frame is ready for transmission, according to some embodiments of the invention;

FIG. 4 illustrates an example of steps carried out by a non-AP station or by an AP station for requesting a change of the MAC address of the non-AP station (if these steps are carried out by the non-AP station) or of a non-AP station (if these steps are carried out by the AP station), according to some embodiments of the invention;

FIG. 5 illustrates an example of steps carried out by a non-AP station or by an AP station for changing the MAC address of the non-AP station (if these steps are carried out by the non-AP station) or of a non-AP station (if these steps are carried out by the AP station) upon reception of a MAC address change request, according to some embodiments of the invention;

FIG. 6 illustrates a first example of a sequence of steps for operating a procedure for changing the MAC address of a non-AP station associated with an AP station, according to some embodiments of the invention;

FIG. 7 illustrates a second example of a sequence of steps for operating a procedure for changing the MAC address of a non-AP station associated with an AP station, according to some embodiments of the invention;

FIG. 8 illustrates examples of frame formats to activate and operate a MAC address change procedure;

FIG. 9 illustrates an example of a frame format for operating a MAC address change procedure initiated by an AP station, according to some embodiments of the invention; and

FIG. 10 illustrates an example of a communication device of a wireless network, configured to implement at least one embodiment of the present invention.

### DESCRIPTION OF SOME EMBODIMENTS

According to some embodiments of the invention, it is provided a method for changing a value of an Extended Unique Identifier (EUI) of a non-access point (non-AP) station, for example a MAC address of the non-AP station, associated with an access point (AP) station. The non-AP station and the AP station both initiate at the same time the EUI change process, and have the same duration to perform the actual EUI change. During the so-called transition period (period of time between the initiation and the termination of the EUI change procedure), both the new and old EUIs are valid, and can be used by the AP station and/or the non-AP station. To do so, a new EUI called transient EUI is associated with the non-AP station. At the end of the transition period, the current EUI is replaced by the transient EUI, and the old EUI is not used any more.

During the transition period, the AP station and the non-AP station monitor the EUIs used for the frame transmission to determine if the EUI change is effective or not. In order to reduce the transition duration, stations may use a different EUI than the emitter EUI to acknowledge the reception of the frame depending on the exitance of buffered frames with old EUI or not.

The transition duration can be exchanged during the association procedure, for instance in a dedicated information element broadcasted in AP's beacon frames, or in probe request or in probe response frames that can be exchanged during the association procedure. Alternatively, the duration may be indicated in a EUI change request frame.

In order to secure the duration of the transition period, both the AP station and the non-AP station may initiate a timer with the value of the transition period. Upon expiration of this timer, both the AP and the non-AP station should apply the EUI change (if it is not already done).

For the sake of illustration, the examples provided hereafter are directed to changing the value of a MAC address of a non-AP station. Changing the value of a EUI of a non-AP station, for example its station AID, applies similarly.

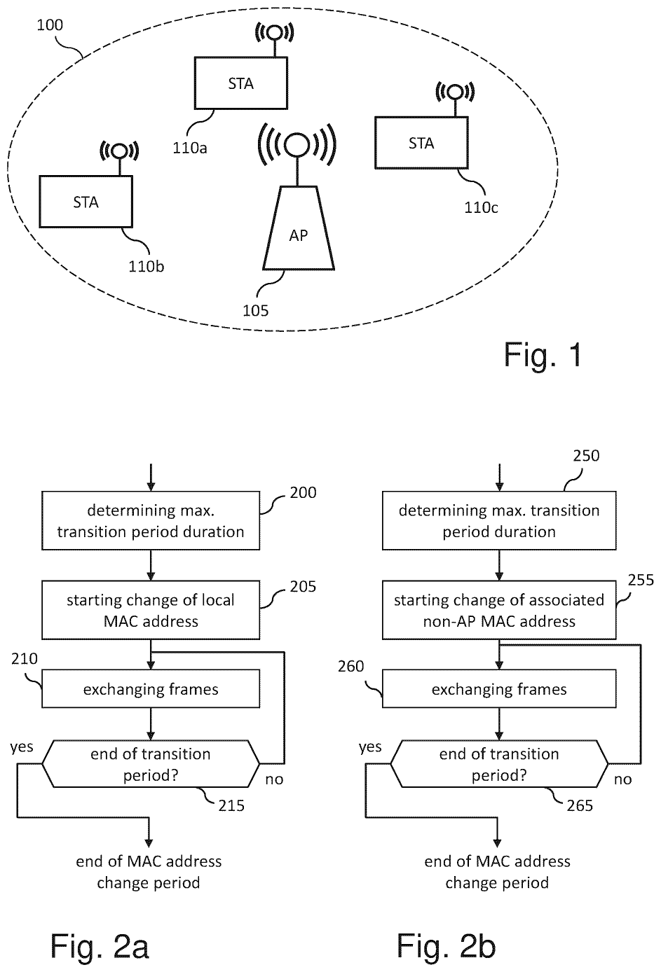

FIG. 1 illustrates an example of a network system in which some embodiments of the invention may be implemented.

For the sake of illustration, FIG. 1 represents an 802.11 network (i.e. a Wi-Fi network) system 100 comprising four wireless devices: an access point station (AP) 105 and three non-AP stations (non-AP STAs) 110a, 110b, and 110c. Of course, the number of non-AP stations 110a, 110b, and 110c may be different from three. AP station 105 provides wireless connections between non-AP stations 110a, 110b, 110c and a wider network, such as the Internet (not represented). The connection of one of non-AP station 110a, 110b, and 110c to AP 105 may be performed by a standardized process called association. Once a non-AP station is associated with the AP station, the non-AP station can send data to the network and receive data from the network through the AP station.

AP station 105 may comprise, be implemented as, or known as a Node B, Radio Network Controller (RNC), evolved Node B (eNB), 5G Next generation base station (gNB), Base Station Controller (BSC), Base Transceiver Station (BTS), Base Station (BS), Transceiver Function (TF), Radio Router, Radio Transceiver, Basic Service Set (BSS), Extended Service Set (ESS), Radio Base Station (RBS), or some other terminology. It can be a standalone product or it may be integrated in a device, for instance in a broadband remote access server (BRAS).

Non-AP stations 110a, 110b, and/or 110c may comprise, be implemented as, or known as a subscriber station, a subscriber unit, a mobile station (MS), a remote station, a remote terminal, a user terminal (UT), a user agent, a user device, a user equipment (UE), a user station (STA), or some other terminology. In some implementations, a non-AP station may be or may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or a smartphone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, some of non-AP stations 110a, 110b, and 110c may be wireless nodes. Such a wireless node may provide, for example, connectivity for or to a network (e.g., a wide area network such as the Internet or a cellular network) via a wired or wireless communication link.

AP station 105 manages a set of stations that together organize their accesses to the wireless medium for communication purposes. All the stations (AP station 105 and non-AP stations 110a, 110b, and 110c) form a service set, which may be referred to as basic service set, BSS (although other terminology can be used). It is noted that AP station 105 may manage more than one BSS: each BSS is thus uniquely identified by a specific basic service set identifier (BSSID) and managed by a separate virtual AP station implemented in physical AP station 105.

FIG. 2a illustrates an example of steps performed at a non-AP station to change its MAC address, according to some embodiments of the invention.

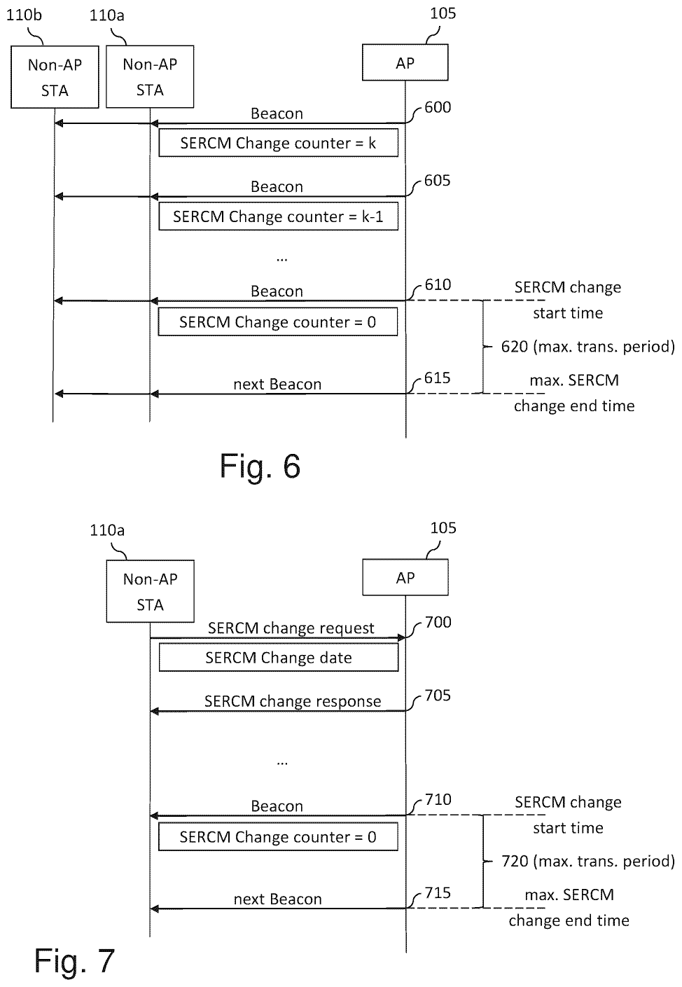

The algorithm illustrated in FIG. 2a is carried out by a non-AP station at a SERCM change start time, for example the start time referenced 610 in FIG. 6 or 710 in FIG. 7.

As illustrated, a first step is directed to determining a maximum SERCM transition period duration (step 200), referred to as the SERCM transition period duration, transition period duration, or transition duration hereafter. This duration can be defined as a time value expressed in millisecond, TU (Time Unit), as a number of TBTTs (Target Beacon Transmission Times), or by any other indication representative of a duration. According to some embodiments, determining the SERCM transition period duration is based on a level of use of a transmission buffer and/or by retrieving a value stored upon reception of an information element, such as information element 900 in FIG. 9. According to other embodiments, the transition duration is a predefined value, for example a value defined by the 802.11 standard. Still according to other embodiments, the transition duration is a combination of a received value and a value set by an administrator, for example the maximum of a received value and a value set by an administrator.

Next, the change of the local MAC address, from the current MAC address (also referred to as the old MAC address), denoted @MAC (n), to a new MAC address, denoted @MAC (n+1), begins by initiating the transition period (step 205). Initiating the transition period may comprise indicating to the physical (PHY) layer that new MAC address @MAC (n+1) should be added to the list of MAC addresses that the AP station handles, as a transient MAC address. From the PHY layer point of view, all the packets addressed with one of the MAC addresses included in this list should be decoded and forwarded to the MAC layer for further actions. Currently, the MAC layer already handled different MAC addresses (typically, the PHY handle a single unicast MAC address of the station, and potentially group addresses of groups to which belongs the station).

In some embodiments of the invention, the PHY layer of the considered non-AP station handles two unicast MAC addresses: the first one is the classical unicast MAC address of the station seen as a unique identifier of the station and the second one is a transient unicast MAC address. The presence of two unicast MAC addresses is only valid during the transition period. The setting of the unicast MAC addresses by the MAC layer can for instance be performed thanks to a request known as the PHY-CONFIG request that is part of the PHY SAP (Service Access Point) interface as defined in the 802.11 standard. In some embodiments of the invention, a function is added to the PHY SAP to define the transient MAC address. In other embodiments, the transient MAC address is added as a new parameter to the PHY CONFIG function that is used to configure the different parameters of the PHY layer.

After setting the transient MAC address with the new MAC address, the PHY layer is able to decode the frames address to the non-AP station (value of the RA field) either by its unique MAC address or its transient MAC address.

In addition, during the step of initiating the transition period (step 205), the non-AP station set the value of two bits that may be used to determine the status of its local transmission buffer, denoted Local transmission Buffer Status (or LocalBS) in the following, and of the transmission buffer of the AP station with which the non-AP station is associated, denoted RemoteBS in the following. These two bits respectively indicate whether the local transmission buffer and the AP station's transmission buffer contain some packets that are ready for transmission and that are to be addressed according to the old MAC address (i.e. @MAC (n)), or contain some frames ready for transmission or retransmission and that are addressed with the old MAC address. According to some embodiments, the RemoteBS bit is set to false to indicate that the non-AP station considers that the transmission buffer of the AP station contains data to be transmitted with the old MAC address, during the step of initiating the transition period. During the transition period, the RemoteBS bit is set to true to indicate that the non-AP station considers that the transmission buffer of the AP station does not contain data to be transmitted with the old MAC address. Still during the step of initiating the transition period, the LocalBS is set to false if the local transmission buffer is not empty (meaning that the local buffer contains data to be transmitted with the old MAC address) and to true otherwise.

As mentioned above, the transition period ends after a transition period duration or earlier depending on the state of the local buffer and of the transmission buffer of the AP station. Accordingly, in some embodiments, the non-AP station initiates a timer with the duration value determined at step 200. When this timer expires, the transition period ends. In such a case, both LocalBS and RemoteBS bits are forced to true, and the MAC address change period ends.

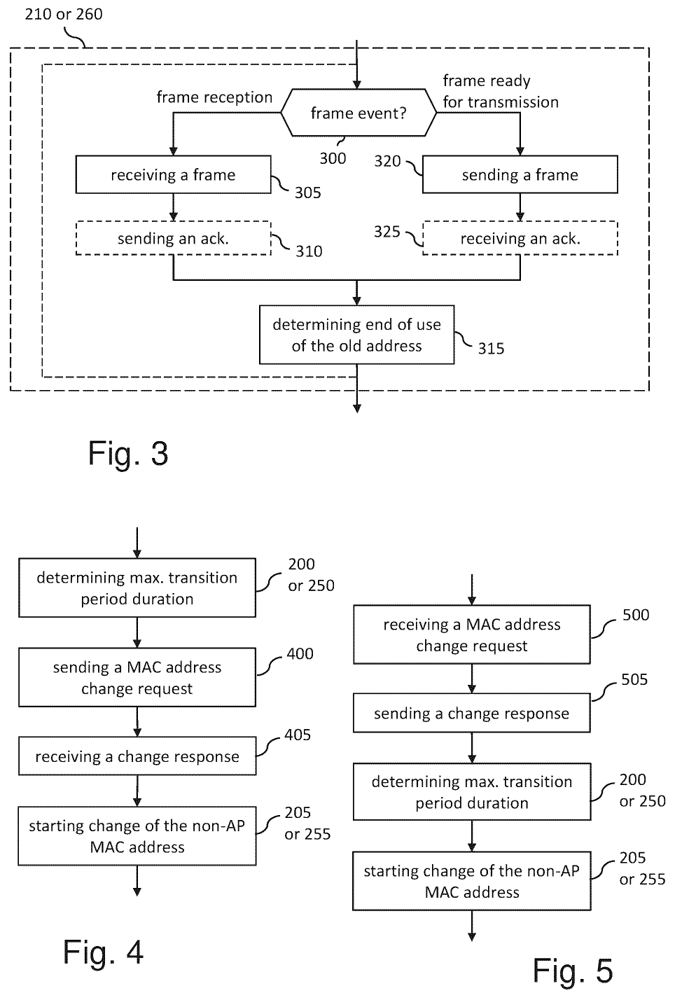

The use of a timer to limit the maximum duration of the transition period may be relevant in particular conditions, for example when the AP station or the non-AP station set the receiving address of acknowledgment frames with the value of the transmitting address of the frame to acknowledge (the management of the acknowledgment addresses is described in more detail by reference to step 310 in FIG. 3). In such a case, if the AP station, respectively the non-AP station, has no frame to send to the non-AP station, respectively to the AP station, there is no way for the non-AP station, respectively to the AP station, to determine the status of the AP station's transmission buffer, respectively of the non-AP station's transmission buffer.

According to some embodiments, all the new packets prepared for transmission and stored in the local transmission buffer are addressed, during the transition period, using the value of the transient MAC address (new Mac address @MAC (n+1)). This ensures that no new packet addressed with the old MAC address (@MAC (n)) will be added to the local transmission buffer.

As illustrated in FIG. 2a, the non-AP station sends and receives packets, during step 210, to purge the content of its transmission buffer that may contain some packets prepared in advance and that contain the old MAC address (@MAC (n)). The transmission of these packets follows the usual medium access rules as defined by the standard.

An example of a mechanism for sending and receiving packets (step 210) is described in more details with reference to FIG. 3.

After receiving or transmitting packets (or in parallel), the non-AP station determines whether the transition period should be stopped (step 215). The transition period should be stopped either because it is determined that the old MAC address is not needed any more or because the maximum transition period duration elapsed.

According to some embodiments, if both LocalBF and the RemoteBF bits are set to true, the non-AP station determines that the old MAC address is not needed any more and the transition period ends. Otherwise, the algorithm loops on step 210 as illustrated.

When both LocalBF and the RemoteBF bits are set to true, the non-AP station set the “standard” unique MAC identifier with the value of the transient MAC address. In this case, the two MAC addresses (i.e. the MAC address and the transient MAC address) have the same value, and the transition period is considered as over. In some embodiments, if a timer has been set during the MAC address initiation process (step 205), the timer is deactivated.

If the maximum transition period duration elapses while the old MAC address is still used, the packets or the frames stored in the non-AP station's transmission buffer, that should use the old MAC address to be transmitted, may be discarded. In some embodiments, these packets may be modified so as to be transmitted with the new MAC address.

FIG. 2b illustrates an example of steps carried out by an AP station for changing the MAC address of one of its associated non-AP station, according to some embodiments of the invention.

Similarly to the algorithm described by reference to FIG. 2a, the algorithm illustrated in FIG. 2b is carried out by an AP station at a SERCM change start time, for example the start time referenced 610 in FIG. 6 or 710 in FIG. 7.

Likewise, a first step is directed to determining a maximum SERCM transition period duration (step 250), also referred to as the SERCM transition period duration, transition period duration, or transition duration. Step 250 is similar to step 200 in FIG. 2a. The SERCM transition period duration may be based on a level of use of a transmission buffer and/or retrieved from a value stored upon reception of an information element, such as information element 900 in FIG. 9, may be a predefined value, for example a value defined by the 802.11 standard, or may correspond to a combination of a received value and a value set by an administrator, for example the maximum of a received value and a value set by an administrator.

Next, the change of the MAC address of the considered non-AP station, from the current MAC address (also referred to as the old MAC address) @MAC (n) to the new MAC address @MAC (n+1), begins (step 255) by indicating, in association with the non-AP station, a transient MAC address (@MAC (n+1)) in addition to its unique MAC address (@MAC (n)). It is recalled here that AP stations maintain some internal table to store a set of parameters for each station associated with it. In some embodiments, the transient MAC address is a new entry of this table and is set with the value of the new MAC address for the considered non-AP station.

In addition, during the step of initiating the transition period (step 255), the AP station set the value of two bits, associated with the considered non-AP station (i.e. the non-AP station that MAC address is being changed), that may be used to determine the status of its local transmission buffer, denoted Local transmission Buffer Status (or LocalBS) in the following, and of the transmission buffer of the considered non-AP station, denoted RemoteBS in the following. These two bits respectively indicate whether the AP station's transmission buffer and the considered non-AP station's transmission buffer contain some frames that are ready for transmission and that are to be addressed according to the old MAC address (i.e. @MAC (n)). According to some embodiments, the RemoteBS bit is set to false to indicate that the AP station considers that the transmission buffer of the considered non-AP station contains data to be transmitted with the old MAC address, during the step of initiating the transition period. During the transition period, the RemoteBS bit is set to true to indicate that the AP station considers that the transmission buffer of the non-AP station does not contain data to be transmitted with the old MAC address. Still during the step of initiating the transition period, the LocalBS is set to false if the AP station's transmission buffer contains data to be transmitted to the considered non-AP station (with the old MAC address) and to true otherwise.

As mentioned above, the transition period ends after a transition period duration or earlier depending on the state of the local buffer and of the transmission buffer of the considered non-AP station. Accordingly, in some embodiments, the AP station initiates a timer with the duration value determined at step 250. When this timer expires the transition period ends. In such a case, both LocalBS and RemoteBS bits are forced to true, and the MAC address change period ends.

According to some embodiments, all the new packets prepared for transmission to the considered non-AP station and stored in the local transmission buffer are addressed, during the transition period, using the value of the transient MAC address of the considered non-AP station (new Mac address @MAC (n+1)). This ensures that no new packet addressed with the old MAC address (@MAC (n)) will be added to the transmission buffer.

Steps 260 and 265 in FIG. 2b are similar to steps 210 and 215 described by reference to FIG. 2a.

If the maximum transition period duration elapses while the old MAC address is still used, the packets or the frames stored in the AP station's transmission buffer, that should use the old MAC address to be transmitted, may be discarded. In some embodiments, these packets may be modified so as to be transmitted with the new MAC address.

An example of a mechanism for sending and receiving packets (step 260) is described in more details with reference to FIG. 3.

FIG. 3 illustrates an example of steps performed at a non-AP station or at an AP station upon reception of a frame or when a frame is ready for transmission (e.g. step 210 or 260 in FIG. 2a or 2b, respectively), according to some embodiments of the invention.

As illustrated, upon detecting a frame event (step 300) and if the frame event is directed to reception of a frame, the frame is received (step 305) by the station to which it is addressed (the considered non-AP station or the AP station with which the considered non-AP station is associated). A test is carried out to determine whether the received frame has been sent using the new MAC address. If the new MAC address has been used, the RemoteBS bit is set to true. In addition, if the received frame requires an acknowledgment, an acknowledgment is sent to the station having transmitted the frame (step 310), otherwise step 315 is directly carried out (step 310 is optional).

When acknowledging a received frame, the station having received the frame prepares an acknowledgment to be sent to the emitter of the frame and identifies the MAC address of the station to which the acknowledgment is to be sent.

According to some embodiments, the receiving MAC address (RA) of the acknowledgment frame (i.e. the acknowledgment recipient's MAC address to use) is the same as the one indicated as the emitting address of the received frame (i.e. the MAC address of the emitter of the frame to be acknowledged, as indicated in this frame). This embodiment follows the standard acknowledgement mechanism.

According to other embodiments, the receiving MAC address (RA) of the acknowledgment frame is set as a function of the value of the LocalBF bit. For example, if the local transmission buffer does not contain any packet addressed with the old MAC address, the acknowledgment frame will be addressed using the new MAC address (i.e. the transient MAC address), regardless the address indicated as the emitting address of the received frame. On the contrary, if the local transmission buffer contains one or more packets addressed with the old MAC address, the acknowledgment frame will be addressed using the old MAC address, regardless the address indicated as the emitting address of the received frame. Therefore, according to these embodiments, an acknowledgment can be addressed using a receiving address (RA address) different from the transmitting address (TA address) of the received packet. This mechanism is different from the current implementation, and allows a receiving station to indicate to the transmitting station that it is ready to change the MAC address, since it contains no more packet addressed with the old MAC address in its buffer. Therefore, these embodiments allow a faster change of the MAC address, i.e. they make it possible to reduce the transition period.

Next, after having sent an acknowledgment or if no acknowledgment is to be sent, the station having received the frame determines whether the old MAC address of the considered non-AP station is still used and thus, whether the change of MAC address is done. If both the LocalBF and the RemoteBF bits are set to true, the station determines that the old MAC address does not need to be maintained anymore and thus, that the transition period may be terminated (as described by reference to steps 215 and 265 in FIGS. 2a and 2b, respectively).

As illustrated, upon detecting a frame event (step 300) and if the frame event is directed to transmission of a frame (e.g. by determining that the local transmission buffer of the station carrying the steps illustrated in FIG. 3 is not empty), the station tries to access the medium for data transmission, and transmits at least a part of the buffered data (step 320). The data are sent to the considered non-AP station or to the AP station with which the considered non-AP station is associated (depending whether the steps illustrated in FIG. 3 are carried out in the considered non-AP station or in the AP station with which the considered non-AP station is associated).

According to some embodiments, the data stored in the local transmission buffer that are ready for transmission and that should be transmitted using the old MAC address should be sent before the data stored in the local transmission buffer that are ready for transmission and that should be transmitted using the new MAC address. Thus, when transmitting data, the station checks whether the data are transmitted using the old MAC address or the new MAC address and if the data are transmitted using the new MAC address, the station set the LocalBF bit to true in order to indicate that there is no more data stored in the local transmission buffer that are to be transmitted using the old MAC address.

If the transmitted frame requires an acknowledgment, the station waits for an acknowledgment (step 325), otherwise step 315 is directly carried out (step 325 is optional).

Upon receiving an acknowledgement corresponding to a transmitted frame (step 325) and if this frame has been transmitted using the old MAC address, the station compares the receiving MAC address (RA) of the acknowledgment frame with the emitting address of the corresponding transmitted frame.

In some embodiments, the received acknowledgments have always the same receiving address as the transmitting address of the corresponding frames transmitted by the station (step 320), according to the standard implementation of the acknowledgment mechanism. In these embodiments, the station cannot determine the status of the remote transmission buffer (i.e. whether is contains data to be transmitted using the old MAC address), and relies on the reception of frames to determine the status of the remote transmission buffer, as described with reference to step 305.

In other embodiments, the receiving address of the received acknowledgment may be different from the transmitting address of the corresponding transmitted frame, as described with reference to step 310. According to these embodiments, if the receiving MAC address of the acknowledgment frame is set to the new MAC address, the RemoteBF bit is set to true to indicate that the transmission buffer of the station transmitting the acknowledgment does not contain any data to be transmitted using the old MAC address.

Next, after having received an acknowledgment or if no acknowledgment is to be received, the station having sent the frame determines whether the old MAC address of the considered non-AP station is still used and thus, whether the change of MAC address is done. If both the LocalBF and the RemoteBF bits are set to true, the station determines that the old MAC address does not need to be maintained anymore and thus, that the transition period may be terminated (as described by reference to steps 215 and 265 in FIGS. 2a and 2b, respectively).

FIG. 4 illustrates an example of steps carried out by a non-AP station or by an AP station for requesting a change of the MAC address of the non-AP station (if these steps are carried out by the non-AP station) or of a non-AP station (if these steps are carried out by the AP station), according to some embodiments of the invention.

As illustrated, a first step is directed to determining the maximum transition period duration. It corresponds to step 200 of FIG. 2a (if the station carrying out the step of FIG. 4 is a non-AP station) or to step 250 of FIG. 2b (if the station carrying out the step of FIG. 4 is an AP station).

According to some embodiments, this step can be performed by using a predetermined duration indicated by a system administrator. According to other embodiments, the duration can be determined according to an amount of data stored in a local transmission buffer, for example data that are to be transmitted using the old MAC address of the considered non-AP station. According to still other embodiments, the duration can be determined as a function of an amount of data stored in a transmission buffer of a remote station (e.g. the considered non-AP station if the steps of FIG. 4 are carried out by an AP station, or an AP station if the steps of FIG. 4 are carried out in the considered non-AP station), this amount of data being used to increase or decrease the transition period duration to better match the estimated time requested to purge the transmission buffers from the data addressed with the old MAC address. These embodiments may be combined to determine the maximum transition period duration.

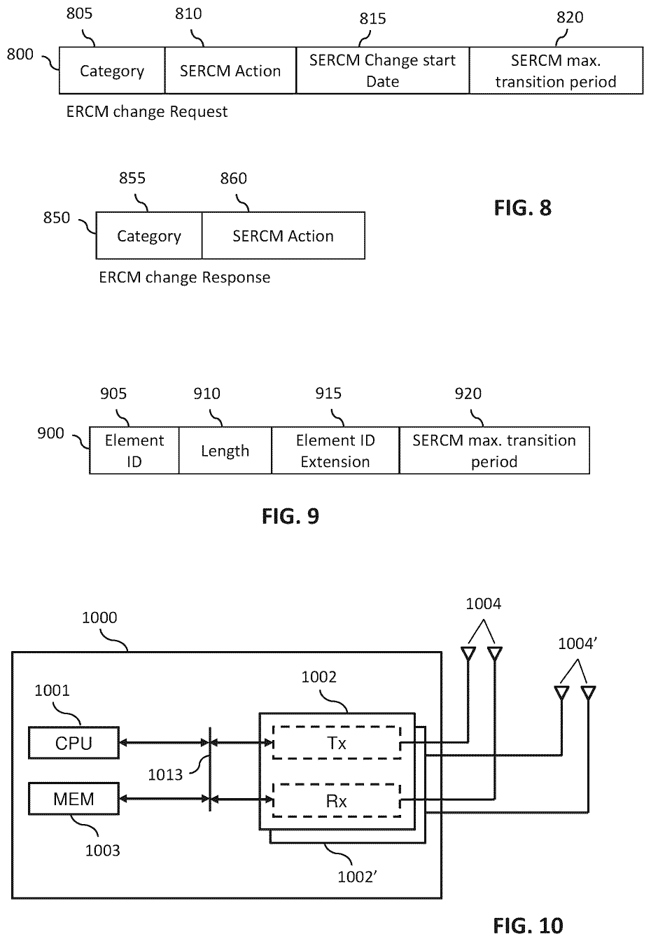

Next, a MAC address change request frame (or SERCM MAC address change request frame) is sent (step 400). This frame may comprise the maximum transition period duration determined previously. Such a frame may comply with the format illustrated in FIG. 8.

Upon reception of a response to the MAC address change request (step 405), it is determined that the MAC address change is accepted. Accordingly, the MAC address change may start (steps 205 and following of FIG. 2a if the station carrying out the step of FIG. 4 is a non-AP station or steps 255 and following of FIG. 2b if the station carrying out the step of FIG. 4 is an AP station).

FIG. 5 illustrates an example of steps carried out by a non-AP station or by an AP station for changing the MAC address of the non-AP station (if these steps are carried out by the non-AP station) or of a non-AP station (if these steps are carried out by the AP station) upon reception of a MAC address change request, according to some embodiments of the invention.

As illustrated, a first step is directed to receiving a MAC address change request frame (step 500), or SERCM MAC address change request frame, for example a frame complying with the format illustrated in FIG. 8. Upon reception of the MAC address change request frame, it is determined whether the latter comprise a maximum transition period duration (e.g. the value of the SERCM max. transition period field 820 in FIG. 8). In such a case, it is stored.

Next, it is determined whether the MAC address change can occur. If the MAC address change can occur, the station carrying out the steps illustrated in FIG. 5 sends back a change response (or SERCM change response) to indicate that the MAC address change is accepted (step 505).

Next, the maximum transition period duration is determined. It corresponds to step 200 of FIG. 2a (if the station carrying out the step of FIG. 5 is a non-AP station) or to step 250 of FIG. 2b (if the station carrying out the step of FIG. 5 is an AP station).

According to some embodiments, this step can be performed by using a maximum transition period duration received previously, for example the maximum transition period duration received in step 500.

After having determined the maximum transition period duration, the MAC address change may start (steps 205 and following of FIG. 2a if the station carrying out the step of FIG. 5 is a non-AP station or steps 255 and following of FIG. 2b if the station carrying out the step of FIG. 5 is an AP station).

FIG. 6 illustrates a first example of a sequence of steps for operating a procedure for changing the MAC address of a non-AP station associated with an AP station, according to some embodiments of the invention.

The MAC address changing procedure basically comprises two phases: a first phase during which new MAC addresses for one or more non-AP stations are computed and during which the AP station and the one or more non-AP stations identify the effective change start time, and a second phase corresponding to an effective change of the MAC addresses of these non-AP stations. The effective change of a MAC address starts at a time called SERCM change start time and ends at the latest at a time called maximum SERCM change end time, from which the new calculated MAC address is used for data exchanges between the considered non-AP stations and the AP station with which they are associated. Therefore, during the changing procedure, each considered non-AP station changes its MAC address from a current value @MAC (n) to a new value @MAC (n+1). During the transition period, both current and new values for the MAC address are valid.

The new MAC address(es) must be calculated by the considered non-AP station(s) and by the AP station.

At the SERCM change start time, the non-AP station(s) and the AP station start the effective change address procedure and, at the maximum SERCM change end time (or earlier), they modify their respective registry by updating the MAC address of each of the considered non-AP stations from @MAC (n) to @MAC (n+1).

In other words, at the starting of the transition period, both AP and non-AP STA initiate the MAC address change for the changing non-AP STA.

The way the AP station and the non-AP stations determine the new MAC addresses to be used is out of scope of the disclosure. The AP station and the non-AP stations may, for instance, store a list of MAC addresses, and each time a change of MAC address must be performed, the next value in the list is chosen as the new MAC address. Such embodiments could however present security problems, if a third party had access to the list. Alternatively, the same function may be used by a non-AP station and the AP station with which it is associated to determine, for example, an index of the next MAC address to use in a predetermined list of MAC addresses. This index may be advantageously determined randomly.

Another MAC address selection method can be used. For example, it may be based on the usage of a pseudorandom function (PRF) with the same input parameters. Therefore, both a non-AP station and the AP station with which it is associated obtain the same address value @MAC (n+1).

Back to FIG. 6 and by reference to FIG. 1, it is illustrated a changing procedure initiated by AP station 105 and intended to non-AP stations 110a and 110b of the BSS for which the initiation procedure has been performed. In other words, according to these embodiments, AP station 105 indicates to non-AP stations 110a and 110b for which the initiation procedure has been performed that they have to change their respective MAC addresses, and non-AP stations 110a and 110b initiate the change of their respective MAC addresses at the same time (the SERCM change start time).

For the sake of illustration, the SERCM change start time may be expressed in terms of a number of Target Beacon Transmission Times (TBTTs). Of course, the SERCM change start time may be expressed differently, for example as an actual time (which may be rounded to avoid any problem due to an imperfect synchronization of the clocks of the non-AP and AP stations).

According to IEEE 802.11 standards, an AP station periodically (every TBTT) transmits beacon frames to the non-AP stations of the BSS, which are management frames containing information relative to the network. Therefore, beacon frames may include a field storing an item of information to indicate a SERCM change date. For example, such an item of information may represent a value of a counter that is decremented within each successive beacon frame transmitted by the AP station so as to indicate that a change of MAC address is in progress and to indicate the SERCM change date. For example, each beacon frame transmitted by AP station 105 to non-AP stations 110a and 110b of the BSS may contain an information element as described below with reference to FIG. 9. The counter may be initially set to a value corresponding to the time at which the change must be operated (for instance, an initial value of k may indicate that the change must be operated in (k+1) TBTTs, k being an integer), and decremented of one unit at each transmission of a next beacon frame. When the counter reaches the value 0, the change must be operated. Therefore, all transmissions of frames subsequent to the beacon frame associated with a counter equal to 0 must be performed with the new MAC address.

With reference to FIG. 6, non-AP stations 110a and 110b receive a beacon frame including a counter, denoted SERCM Change counter, initially set to value k (step 600). It indicates that non-AP stations 110a and 110b (for which an initiation procedure has been done) must change their respective MAC addresses at a time corresponding to (k+1) TBTTs. Then, a next beacon frame is sent from AP station 105 to non-AP stations 110a and 110b (step 605), comprising SERCM Change counter with a value (k−1). After (k+1) beacon frame transmissions, AP station 105 sends a beacon frame with SERCM Change counter equal to 0 to non-AP stations 110a and 110b (step 610), indicating that the change of the respective MAC addresses of non-AP stations 110a and 110b must be initiated. The new addresses of non-AP stations 110a and 110b should be determined at any time between steps 600 and 610, that it to say after requesting the MAC address change and before starting the effective MAC address change.

All the transmissions between AP station 105 and non-AP stations 110a and 110b, occurring after max. SERCM change end time 615, should be performed with the new MAC addresses of non-AP stations 110a and 110b.

The transition duration (referenced 620) between SERCM change start time 610 and max. SERCM change end time 615 advantageously allows the AP station and the non-AP stations to transmit the frames addressed with the old MAC address @MAC (n) that were buffered in their transmission buffer. This allows to change the MAC address without breaking the on-going transmissions, making it possible that frequent MAC address changes do not have negative effects on the performances.

Even if the embodiments described by reference to FIG. 6 use beacon frames, it has to be understood that other types of frames may be used similarly.

FIG. 7 illustrates a second example of a sequence of steps for operating a procedure for changing the MAC address of a non-AP station associated with an AP station, according to some embodiments of the invention.

According to the alternative embodiments illustrated in FIG. 7, the MAC address changing procedure may be initiated by non-AP station 110a.

As illustrated, a request for changing the MAC address of the considered non-AP station (i.e. non-AP station 110a in this example) is sent from non-AP station 110a to AP station 105 (step 700). This request may be an “SERCM change Request”, for example “SERCM change Request” 800 as described below with reference to FIG. 8. This request may contain an indication relative to the SERCM change date and to the SERCM max. transition period duration.

For the sake of illustration, it may comprise a field (e.g. a SERCM Change Date field 815, as illustrated in FIG. 8) indicating, for example in terms of TBTTs, the date of the next MAC address change. For example, a value set to k may indicate that the change must be operated in (k+1) TBTTs, and a value set to 0 may indicate that the next MAC address is to be applied immediately. Accordingly, all message transmissions subsequent to the transmission of the beacon frame associated with a counter equal to 0 should be performed by using the new MAC address.

The SERCM change request frame may also contain a field (e.g. a SERCM max. transition period field 820, as illustrated in FIG. 8) indicating the maximum duration of the transition period. At the expiration of the transition period, both the AP station and the non-AP station should use the new MAC address.

As illustrated, in response to the request for changing the MAC address, AP station 105 may acknowledge that it has received the request and that it agrees to change the MAC address of non-AP station 110a (step 705), for example by sending to non-AP station 110a a “SERCM change Response”, for example “SERCM change Response” 850 as described with reference to FIG. 8.

According to some embodiments, non-AP station 110a may implement a counter reflecting the SERCM change date (e.g. a counter equal to k or (k−1)) when it sends the request for changing its MAC address, the SERCM change date being here expressed in a number of TBTTs. Each time a new beacon frame is received from AP station 105, the counter may be decremented by one unit. Upon reception by non-AP station 110a, from AP station 105, of the beacon frame corresponding to the SERCM date, i.e. when the counter reaches the value zero (step 710), the change of the MAC address is initiated. At the end of the transition period (reference 720), the new MAC address of non-AP station 110a is effective (at the beginning of the next TBTT). This means that all transmissions subsequent to the transmission of the beacon frame corresponding to the maximum SERCM change end time (step 715) are done with the new MAC address.

It is noted that the new addresses of non-AP station 110a should be determined at any time between steps 700 and 710, that it to say after requesting the MAC address change and before starting the effective MAC address change.

Although the examples described with reference to FIGS. 6 and 7 are based on the use of beacon frames and TBTTs, there exist other embodiments. Indeed, according to some embodiments, it may be needed to share, between the considered non-AP stations and the AP station with which they are associated, an indication relative to the time at which the change is to be made, and to provide the non-AP stations and the AP station with means for counting the time. For example, it is possible to send an actual date, as long as the non-AP station and the AP station have access to the same clock or can synchronize their clocks. Changes of MAC addresses may be performed periodically, at predetermined times, or on requests.

It is also noted that, based on the example illustrated in FIG. 6, an AP station may request that only one non-AP station changes its MAC address. To that end, a SERCM change request similar to the one described by reference to FIG. 7 may be sent from the AP station to the considered non-AP station.

FIG. 8 illustrates examples of frame formats to activate and operate a MAC address change procedure. All frame formats represented in FIG. 8 are identified by a ‘Category’ field assigned to a specific value k in the range [31, 125] as specified in table 9-51 of the IEEE Std 802.11-2020, so far reserved. For the sake of illustration, the category value assigned for SERCM action frame may be set to 31. Another value may be used.

For example, the following may be added in Table 9-51-Category values:

| Code | Meaning |
|---|---|
| k | Seamless Enhanced RCM (SERCM) |

In addition, the frame formats represented in FIG. 8 are further identified by the single octet ‘SERCM Action’ field, which follows immediately the Category field. The values of the SERCM Action field may be defined in the following table, that may be inserted at the end of 9.6 Action frame format details of the standard IEEE Std 802.11-2020:

| Action Field value | Meaning |
|---|---|
| 4 | SERCM change Request |
| 5 | SERCM change Response |

Still for the sake illustration, a SERCM Action field value set to 4 may correspond to a SERCM change Request and a SERCM Action field value set to 5 may correspond to an ERCM change Response.

According to the examples illustrated in FIG. 8, frame format 800 corresponds to a frame for requesting a change of MAC address and frame format 850 corresponds to a frame for responding to a request for changing a MAC address. As illustrated, frame formats 800 and 850 comprise a category field referenced 805 and 855 respectively and a SERCM action field referenced 810 and 860 respectively.

Therefore, SERCM change Request 800 may contain Category field 805 set to value 31 and SERCM Action field 810 set to value 4.

In addition, SERCM change Request 800 may comprise a SERCM Change Date field referenced 815 and a SERCM max. transition period field referenced 820.

SERCM Change Date field 815 may indicate the date on which the change of MAC address is to be applied. According to some embodiments, this date may be expressed as a number of Target Beacon Transmission Times (TBTTs). Other embodiments are possible. For example, the date on which the change of MAC address is to be applied may be an actual date. In such embodiments, the non-AP stations and the AP station should use synchronized clocks (or have access to such clocks) to prevent the change from being made at one device but not at the other.

SERCM max. transition period field 820 may indicate the maximum duration of the MAC address change transition period. Again, it may be expressed as a number of Target Beacon Transmission Times (TBTTs), corresponding to the number of TBTTs between the start of the transition period and its end. This value can also be expressed in millisecond, or in TU (Time unit). Other embodiments are possible.

SERCM change Response 850 may contain Category field 855 set to value 31 and SERCM Action field 860 set to value 5.

FIG. 9 illustrates an example of a frame format for operating a MAC address change procedure initiated by an AP station, according to some embodiments of the invention.

It may correspond to an Information Element (IE) as specified in section 9.4.2 in the standard IEEE Std 802.11-2020.

A dedicated IE may be specified for SERCM procedure, referred to as SERCM IE, for example SERCM IE 900. As illustrated, an IE may be identified by an Element ID, for example Element ID 905, and an Element ID Extension, for example Element ID Extension 915 assigned to a specific value in the range [99,255] as specified in table 9-92 of the IEEE Std 802.11-2020, so far reserved. For the purpose of illustration, the Element ID Extension for identifying a SERCM IE may be set to 99.

Accordingly, Element ID field 905 of SERCM IE 900 may be set to 255 and Element ID Extension field 915 of SERCM IE 900 may be set to 99.

In addition, SERCM IE 900 comprises a Length field referenced 910 that indicates the number of octets in the IE 900, excluding Element ID field 905 and Length field 910. According to the illustrated example, its value is 2.

SERCM IE 900 further comprises a SERCM Change counter field (or SERCM max. transition period), referenced 920.

The SERCM max. transition period field 920 indicates the maximum duration of the transition period. Again, it may be expressed as a number of Target Beacon Transmission Times (TBTTs), corresponding to the number of TBTTs between the start of the transition period and its end. This value can also be expressed in millisecond, or in TU (Time unit). Other embodiments are possible.

FIG. 10 schematically illustrates an example of a communication device, that may correspond any of the stations described by reference to FIG. 1, of a wireless network, configured to implement at least some embodiments of the present invention. The communication device, referenced 1000, may preferably be a device such as a micro-computer, a workstation, or a light portable device. Communication device 1000 may comprise a communication bus 1013 to which may be connected:
a central processing unit 1001, such as a processor, denoted CPU;
a memory 1003, denoted MEM, for storing an executable code of methods or steps of the methods according to embodiments of the invention as well as the registers adapted to record variables and parameters necessary for implementing the methods; and
at least two communication interfaces 1002 and 1002′ connected to the wireless communication network, for example a communication network according to one of the IEEE 802.11 family of standards, via transmitting and receiving antennas 1004 and 1004′, respectively.

Preferably, communication bus 1013 may provide communication and interoperability between the various elements included in the communication device 1000 or connected to it. The representation of the bus is not limiting and in particular the central processing unit is operable to communicate instructions to any element of the communication device 1000 directly or by means of another element of the communication device 1000.

The executable code may be stored in a memory that may either be read only, a hard disk, or on a removable digital medium such as for example a disk. According to an optional variant, the executable code of the programs can be received by means of the communication network, via the interface 1002 or 1002′, in order to be stored in the memory 1003 of communication device 1000 before being executed.

In some embodiments, communication device 1000 may be a programmable apparatus which uses software to implement embodiments of the invention. However, alternatively, some embodiments of the present invention may be implemented, totally or in partially, in hardware (for example, in the form of an Application Specific Integrated Circuit or ASIC).

Embodiment(s) of the present invention can also be realized by a computer of a system or apparatus that reads out and executes computer executable instructions (e.g., one or more programs) recorded on a storage medium (which may also be referred to more fully as a “non-transitory computer-readable storage medium”) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), etc.), a flash memory device, a memory card, and the like.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

A person skilled in the art will readily appreciate that various parameters disclosed in the description may be modified and that various embodiments disclosed may be combined without departing from the scope of the invention.

1. A method for changing a value of an Extended Unique Identifier, EUI, of a non-access point, non-AP, station associated with an access point, AP, station, the non-AP station and the AP station both using a same mechanism for determining a new value of the EUI, the method comprising at one of the non-AP station and the AP station:
obtaining an EUI change start time and a transition period duration;
determining the new value of the EUI; and
from the obtained EUI change start time and for at most the obtained transition period duration, using the EUI value to be changed and the new EUI value for transmitting data to or receiving data from the other of the non-AP station and the AP station.

2. The method of claim 1, wherein at least an item of information for obtaining the EUI change start time is received from or is transmitted to the other of the non-AP station and the AP station.

3. The method of claim 1, further comprising, if it is determined that, before the obtained transition period duration elapsed, none of the non-AP station and the AP station needs to use the EUI value to be changed, shortening the obtained transition period duration.

4. The method of claim 3, further comprising determining whether a transmission buffer of the non-AP station and/or a transmission buffer of the AP station contain data to be transmitted using the EUI value to be changed.

5. The method of claim 4, wherein determining whether a transmission buffer of the other of the non-AP station and the AP station contains data to be transmitted using the EUI value to be changed comprises determining whether a EUI value used to transmit a frame from the other of the non-AP station and the AP station to the one of the non-AP station and the AP station is the new value of the EUI.

6. The method of claim 4, wherein determining whether a transmission buffer of the other of the non-AP station and the AP station contains data to be transmitted using the EUI value to be changed comprises (i) transmitting a frame from the one of the non-AP station and the AP station to the other of the non-AP station and the AP station and (ii) determining whether a EUI value used to receive an acknowledgment of reception of the transmitted frame is the EUI value to be changed.

7. The method of claim 1, wherein at least an item of information for obtaining the transition period duration is received from or is transmitted to the other of the non-AP station and the AP station.

8. The method of claim 1, wherein the transition period duration is determined as a function of an amount of data to be transmitted using the EUI value to be changed.

9. The method of claim 1, wherein the transition period duration is predetermined.

10. The method of claim 1, wherein the obtained transition period duration is transmitted to the other of the non-AP station and the AP station.

11. The method of claim 1, further comprising determining that a value of the EUI is to be changed.

12. The method of claim 1, wherein the EUI of the non-AP station is a MAC address of the non-AP station.

13. The method of claim 2, wherein a request for changing the value of the EUI is sent by the AP station and received by the non-AP station.

14. The method of claim 13, wherein the request for changing the value of the EUI is a beacon frame.

15. The method of claim 14, wherein the item of information for obtaining the EUI change start time is a counter included in the beacon frame, the counter indicating a number of Target Beacon Transmission Times, TBTTs.

16. The method of claim 15, wherein, after sending the request for changing the value of the EUI, a plurality of subsequent beacon frames are sent by the AP station and received by the non-AP station, each subsequent beacon frame including a respective value of the counter, the value of the counter being decremented by one unit for each subsequent beacon frame;
wherein the EUI change start time is a time at which the beacon frame with a value of the counter equal to zero is sent from the AP station and received by the non-AP station.

17. The method of claim 2, wherein a request for changing the value of the EUI is sent by the non-AP station and received by the AP station.

18. The method of claim 17, wherein the item of information for obtaining the EUI change start time is included in the request for changing the value of the EUI.

19. The method of claim 18, wherein the item of information for obtaining the EUI change start time is a number k of Target Beacon Transmission Times, TBTTs, the EUI change start time being a time at which a k-th beacon frame since the communicating of the request is sent from the AP station or received by the non-AP station.

20. The method of claim 18, wherein the item of information for obtaining the EUI change start time is a time value, the EUI change start time being a time at which a beacon frame is sent from the AP station or received by the non-AP station, the beacon frame being sent or received corresponding to a first beacon frame after the time value is reached.

21. The method of claim 1, wherein a physical layer of the non-AP station is configured to manage at least two different values of the EUI and wherein the AP station is configured to manage a list of at least two different values of the EUI, from the obtained EUI change start time and for at most the obtained transition period duration.

22. (canceled)

23. A non-transitory computer-readable storage medium storing instructions of a computer program for implementing each of the steps of the method according to claim 1.

24. A station identified by an Extended Unique Identifier, EUI, value, the station comprising: a memory; and a processing circuitry coupled to the memory, the processing circuitry configured to:
obtain an EUI change start time and a transition period duration;
determine a new value of the EUI; and
from the obtained EUI change start time and for at most the obtained transition period duration, use the EUI value to be changed and the new EUI value for transmitting data to or receiving data from another station.
